(19) United States
(12) Patent Application Publication
(10) Pub. No.: US 2025/0297423 A1
(43) Pub. Date: Sep. 25, 2025

(54) MULTI-LAYER SYNTHETIC LEATHER PRODUCTS

(71) Applicants: Dow Global Technologies LLC, Midland, MI (US); Dow Silicones Corporation, Midland, MI (US)

(72) Inventors: Nan Wang, Shanghai (CN); Yusheng Chen, Shanghai (CN); Guodong Shen, Shanghai (CN); Xiaolin Huang, Shanghai (CN)

(21) Appl. No.: 18/863,185

(22) PCT Filed: Jul. 15, 2022
(86) PCT No.: PCT/CN2022/105944

§ 371 Date: Nov. 5, 2024

(51) Int. Cl. D06N 3/18; C08L 75/12; C08L 83/04; D06N 3/00; D06N 3/12; D06N 3/14

(52) U.S. Cl. CPC D06N 3/183; C08L 75/12; C08L 83/04; D06N 3/0043; D06N 3/128; D06N 3/147

(57) ABSTRACT

Disclosed is a multi-layer synthetic leather product comprising (A) a silicone based top layer; and (B) a polyurethane based skin layer which is formed with a polyurethane dispersion formulation, wherein the polyurethane dispersion formulation is formed by blending water, at least one chain extender and an isocyanate-terminated prepolymer which is the reaction product of a mixture comprising: at least one isocyanate compound, at least one polyol compound, and from 2.5 wt % to 15 wt %, based on the weight of the prepolymer, of at least one allyl polyether monoalcohol. Due to the formation of chemical bonds between the top layer and the skin layer, the synthetic leather product exhibits superior detachment resistance, mechanical strength, easy to clean capability and hand feeling.

### FIELD

The present disclosure relates to a unique multi-layer synthetic leather product in which a polyurethane based skin layer and a silicone based top layer are covalently bonded with each other, thus the synthetic leather product is imparted with significantly enhanced detachment resistance while can still retain superior mechanical strength, easy to clean capability and hand feeling.

### INTRODUCTION

A general technical solution reported in the prior art is to coat a silicone based top coat layer directly onto the outermost surface of the PU based leather with no additional chemical bond so as to produce a semi-silicone PU leather having a multi-layer structure consisting of, from bottom to top, a fabric layer, a foam layer, a PU based skin layer and the silicone based top layer, and exhibiting desired easy to clean capability and hand feeling. Nevertheless, a serious problem accompanied with this solution is the low adhesion strength between the silicone based top layer and the skin layer, which will bring about inferior detachment resistance and poor easy to clean capability. Therefore, there is a long-standing need to develop a unique synthetic leather which has low cost, high detachment resistance and can still achieve the superior performance of the pure silicone based synthetic leather.

After persistent exploration, we have surprisingly developed a unique multi-layer synthetic leather product which can achieve the above stated targets.

### SUMMARY

The present disclosure provides a unique multi-layer synthetic leather product, and a method for preparing the same.

In a first aspect of the present disclosure, a multi-layer synthetic leather product comprising,
(A) a silicone based top layer which is the reaction product of a polysiloxane formulation comprising a first polysiloxane functionalized with at least one Si—H group and a second polysiloxane functionalized with at least one vinyl group; and
(B) a polyurethane based skin layer which is formed with a polyurethane dispersion formulation, wherein the polyurethane dispersion formulation is formed by blending water, at least one chain extender and an isocyanate-terminated prepolymer which is the reaction product of a mixture comprising
   (a) at least one isocyanate compound comprising at least two isocyanate groups;
   (b) at least one polyol compound having a weight average molecular weight from 500 g/mol to 8000 g/mol; and
   (c) from 2.5 wt % to 15 wt %, based on the weight of the prepolymer, of at least one allyl polyether monoalcohol having an allyl group and an hydroxyl group and a weight average molecular weight from 500 g/mol to 8,000 g/mol.

### BRIEF DESCRIPTION OF THE DRAWINGS

FIG. 1 is a schematic view of a multi-layer synthetic leather product according to an embodiment of the present disclosure, illustrating the mechanism by which the chemical bonds between the skin layer and the top layer are formed.

### DETAILED DESCRIPTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

Without being limited to any specific theory, a technical breakthrough of the present disclosure resides in the particularly designed PUD formulation for the skin layer. Especially, it is found that an allyl polyether monoalcohol can be used in combination with the polyol components (e.g., the combination of polytetramethylene ether glycol and another polyether polyol) in the reaction with isocyanates so as to produce polyurethane main chains comprising at least one terminal or pendent allyl group, which further reacts with the reactive groups, e.g. Si—H, Si—OH, Si—CH═CH₂, in the top layer, thus chemically bonding the polyurethane main chains in the skin layer to the siloxane main chains in the top layer and imparting the silicone-PU composite multi-layer synthetic leather product with superior detachment resistance.

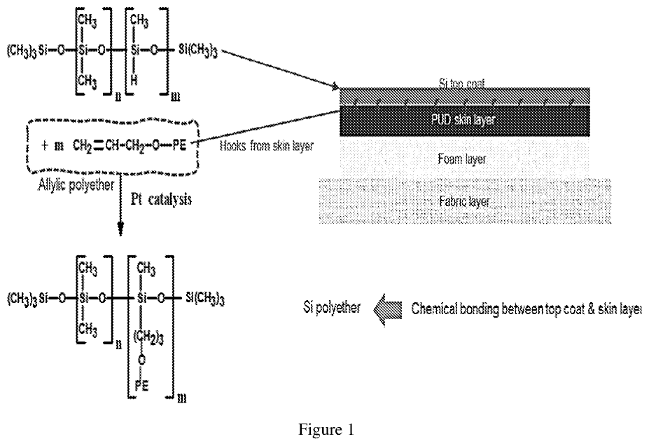

For example, FIG. 1 shows a schematic section view of a multi-layer synthetic leather product according to an embodiment, wherein the synthetic leather product comprises, from top to bottom, (A) a silicone based top layer; (B) a polyurethane based skin layer; (C) a foam layer; and (D) a fabric layer, wherein all the layers are schematic and not in any particular scale. According to the exemplary embodiment shown in FIG. 1, the allyl groups attached to the polyurethane main chains in the skin layer react with the Si—H groups attached to the siloxane main chains in the top layer to form Si—C covalent bond between the skin layer and the top layer. Without being limited to any specific theories, it is also estimated that other reactive groups, e.g. Si—OH or Si—CH═CH₂, attached to the siloxane main chains in the top layer, may also react with the allyl group attached to the polyurethane main chains in the skin layer so as to form covalent bonds, such as “Si—O—C (e.g. via the mechanism of Si—OH+CH₂═CH—CH₂-polyether alcohol→Si—O—CH₂—CH₂—CH₂-polyether alcohol)” or “C—C (e.g. via the mechanism of Si—CH═CH₂+CH₂=CH—CH₂-polyether alcohol→Si—CH₂—CH₂—CH₂—CH₂—CH₂-polyether alcohol)”, between the top layer and the skin layer. The subscripts “m” and “n” as shown in FIG. 1 represents the polymerization degree of the polysiloxane, wherein each of m and n can be independently an integrate of 1 to 2,000, such as from 2 to 1,800, or from 5 to 1,500, or from 10 to 1,200, or from 50 to 1,000, or from 80 to 800, or from 100 to 700, or from 200 to 600, or from 300 to 500, or from 350 to 400, or within a numerical range obtained by combining any two of the above indicated end points.

According to an embodiment, the skin layer is prepared by coating a layer of a PUD formulation onto a release paper, and curing the coated layer.

According to an exemplary embodiment, the PUD can be synthesized by Step A: reacting the component (a) with the component (b) and component (c) to form a prepolymer comprising one or more, e.g. one, two, three, four, five, six, seven or more, free isocyanate group(s); and Step B: blending the prepolymer with water, and optionally, at least one chain extender, to form the internally emulsified polyurethane dispersion. According to an embodiment, the chain extender can be incorporated in the above indicated Step A, Step B, or both. According to a specific embodiment, the chain extender can be incorporated in the above indicated Step B. According to one embodiment, the prepolymer formed in the first step may have an isocyanate groups contents (NCO %) of from 1.0 to 10.0 wt %, based on the weight of the prepolymer, such as from 2.0 to 9.0 wt %, or from 3.0 wt % to 8.0 wt %, or from 3.5 wt % to 7.0 wt %, or from 4.0 wt % to 5.0 wt %.

According to a specific embodiment, the PUD is configured to be internally emulsified. According to another specific embodiment, the PUD only comprises internal emulsifier and is free of external emulsifier. As used herein, the term “internally emulsified” or “internal emulsification” refers to a mechanism in which the emulsification function is substantially or completely contributed by at least one internal emulsifier, which has been covalently integrated within the polyurethane main chain, wherein anionic, cationic or non-ionic surfactant/hydrophilic functionalities, such as carboxylic acid group, sulfonic acid, amine group, etc., can be attached to the polyurethane main chain as terminal or pendant groups. According to an exemplary embodiment, the internal emulsifier can be a compound comprising at least one hydrophilic group and at least two isocyanate-reactive groups, such as a C₂-C₂₀ carboxylic acid compound having at least two hydroxyl groups. Exemplary internal emulsifiers can be selected from the group consisting of dimethylol-formic acid, dimethylol-acetic acid, dimethylol-propionic acid, dimethylol-butanoic acid, dimethylol-pentanoic acid, dimethylol-hexanoic acid, dimethylol-heptanoic acid, dimethylol-nonanoic acid, dimethylol-capric acid, dimethylol-lauric acid, dimethylol-palmitic acid, dimethylol-stearic acid, dimethylol-cyclohexane carboxylic acid, dimethylol-benzoic acid, and any combinations thereof. According to a particular embodiment, the internal emulsifier is dimethylol-butanoic acid, such as 2,2-dimethylol-butanoic acid.

According to a particular embodiment, the PUD is 100% internally emulsified. In other words, no external emulsifier/surfactant is added before, during and after the formation of the PUD.

According to an embodiment, the content of the internal emulsifier is from 1 wt % to 10wt %, based on the weight of the prepolymer, such as within the range from 1.2 wt % to 9 wt %, or within the range from 2.0 wt % to 3.5 wt %, or within the range from 2.7 wt % to 3.0 wt %.

In various embodiments, the isocyanate compound of component (a) has an average NCO functionality of larger than 1, such as larger than 1 and less than 4, or from about 1.5 to about 3, or from about 2 to about 3. In some embodiments, the component (a) includes an isocyanate compound comprising at least two isocyanate groups. In another embodiment, the isocyanate compounds include aromatic or aliphatic polyisocyanates having two or more isocyanate groups, such as linear aliphatic, cyclo-aliphatic or araliphatic polyisocyanates having two or more isocyanate groups. In an embodiment, the isocyanate compounds are selected from the group consisting of C₄-C₁₂ aliphatic isocyanate comprising at least two isocyanate groups, C₆-C₁₅ cycloaliphatic or aromatic isocyanates comprising at least two isocyanate groups, C₇-C₁₅ araliphatic isocyanates comprising at least two isocyanate groups, and a combination thereof. In another embodiment, the isocyanate compounds include m-phenylene diisocyanate, toluene diisocyanate (TDI), diphenylmethanediisocyanate (MDI), methylenebis (cyclohexyl isocyanate) (HMDI), hexamethylene-1,6-diisocyanate (HDI), tetramethylene-1,4-diisocyanate, cyclohexane-1,4-diisocyanate, hexahydrotoluene diisocyanate, hydrogenated MDI, naphthylene-1,5-diisocyanate, isophorone diisocyanate (IPDI), or mixtures thereof.

According to another embodiment, the isocyanate component can be modified multifunctional isocyanates, that is, products which are obtained through chemical reactions and modifications of the above indicated isocyanates compounds. Exemplary modified isocyanates are those containing esters, ureas, biurets, isocyanurates, allophanates, carbodiimides and uretoneimines, such as 4,4′-carbodiimide modified MDI products. Liquid isocyanate compounds containing carbodiimide groups, uretoneimines groups or isocyanurate rings, having isocyanate groups (NCO) contents of from 10 to 40 weight percent, such as from 20 to 35 weight percent, can also be used.

According to a specific embodiment, the component (a) comprises at least 50 wt % IPDI, such as from 50 wt % to 100 wt %, or from 60 wt % to 100 wt %, or from 70 wt % to 100 wt %, or from 80 wt % to 100 wt %, or from 90 wt % to 100%, based on the weight of the component (a).

Generally, the amount of the component (a) may vary based on the actual requirement of the synthetic leather article. For example, as an illustrative embodiment, the content of the component (a) can be from about 14 wt % to about 38 wt %, based on the solid weight of the prepolymer, such as from about 15 wt % to about 30 wt %, or from about 18 wt % to about 25 wt %, or from about 19 wt % to about 22 wt %.

According to another exemplary embodiment, the component (b) comprises one or more polyol compounds, such as at least one polyether polyol having a hydroxyl functionality of 2.0 to 3.0 and a weight average molecular weight (Mw) of 100 to 10,000 g/mol, such as from 200 to 10,000 g/mol, or from 500 to 8,000 g/mol, or from 1,000 to 7,000 g/mol, or from 1,500 to 5,000 g/mol, or from 2,000 to 4,000 g/mol. According to a specific embodiment, the component (b) comprises a polytetrahydrofuran (PTMEG) having a hydroxyl functionality of 2 and a weight average molecular weight (Mw) from 1,500 to 3,000, such as 2,000 g/mol, wherein the content of the PTMEG can be from 40 wt % to 70 wt %, based on the total weight of the prepolymer, such as from about 45 wt % to about 68 wt %, or from about 48 wt % to about 60 wt %.

According to another embodiment, the component (b) further comprises one or more polyether polyol compounds which are different from the above said PTMEG, such as poly(propylene oxide) glycol, poly(ethylene oxide) glycol, poly(propylene oxide)-co-(ethylene oxide) glycol, etc. For example, the polyether polyol other than PTMEG may include a poly(propylene oxide) glycol having a hydroxyl functionality of 2 and a weight average molecular weight (Mw) from 1,000 to 5,000, such as 1,000 g/mol or 4,000 g/mol. The content of the polyether polyol other than PTMEG used herein may range from about 1 wt % to about 15 wt %, based on the weight of the prepolymer, such as from about 3 wt % to about 12 wt %, or from about 5 wt % to about 10 wt %.

Alternatively or additionally, the component (b) may comprise one or more polyol compounds other than the above indicated polyether polyols, and examples of them can be selected from the group consisting of C₂-C₁₆ aliphatic polyhydric alcohol comprising at least two hydroxyl groups, C₆-C₁₅ cycloaliphatic polyhydric alcohol comprising at least two hydroxyl groups, C₆-C₁₅ aromatic polyhydric alcohol comprising at least two hydroxyl groups, polyester polyol having a weight average molecular weight from 1,000 to 8,000 g/mol, polycarbonate diol having a weight average molecular weight from 1,000 to 8,000 g/mol, and a combination thereof.

According to another embodiment, one or more mono-functional monomeric alcohol or mono-functional polymeric alcohol can be used in combination with the above indicated polyol compounds for preparing the prepolymer.

According to an embodiment, the allyl polyether monoalcohol comprises at least one terminal or pendent allyl group attached to the polyether main chain, and the hydroxyl groups can be primary hydroxyl, secondary hydroxyl or a combination thereof. The relative content of the allyl group can be from 0.5 wt % to 8 wt %, based on the weight of the allyl polyether monoalcohol, such as from 0.8 to 5 wt %, or from 1 to 3 wt %. According to a specific embodiment, the allyl polyether monoalcohol comprises one hydroxyl group and one allyl group, each of which is attached to an end of the polyether main chain. The polyether main chain of the allyl polyether monoalcohol may be derived from ethylene oxide, propylene oxide, butylene oxide, tetrahydrofuran, or copolymer thereof. According to a specific embodiment, the polyether main chain of the allyl polyether monoalcohol can be homopolymers such as poly(ethylene oxide), poly(propylene oxide), poly(butylene oxide) or polytetrahydrofuran. According to some embodiments, the polyether main chain of the allyl polyether monoalcohol can be random copolymeric, block copolymeric or graft copolymeric polyether chain, and may include poly(ethylene oxide)-co-(propylene oxide), poly(ethylene oxide)-co-(butylene oxide), poly(butylene oxide)-co-(propylene oxide), poly(ethylene oxide)-co-(polytetrahydrofuran), poly(polytetrahydrofuran)-co-(butylene oxide) or poly(polytetrahydrofuran)-co-(propylene oxide). According to another specific embodiment, the polyether main chain of the allyl polyether monoalcohol can be a copolymer of poly(ethylene oxide)-co-(propylene oxide), wherein the weight ratio between the ethylene oxide repeating unit and the propylene oxide repeating unit can be from 5/95 to 95/5, or from 10/90 to 90/10, or from 15/85 to 85/15, or from 20/80 to 80/20, or from 25/75 to 75/25, or from 30/70 to 70/30, or from 35/65 to 65/35, or from 40/60 to 60/40, or from 45/55 to 55/45, or from 45/55 to 50/50, or within a range obtained by combining any two of the above stated end points.

According to an embodiment, the allyl polyether monoalcohol may have a weight average molecular weight from 500 to 8,000 g/mol, such as from 500 to 6,000 g/mol, or from 1,000 to 4,000 g/mol, or from 1,500 to 3,000 g/mol, or from 1,500 to 2,000 g/mol, or within a range obtained by combining any two of the above stated end points. According to another embodiment, the allyl polyether monoalcohol may have a OH number from 20 to 200 mg OH/g, such as from 25 to 100 mg OH/g, or from 30 to 50 mg OH/g.

In general, the content of component (c) used herein may range from about 2.5 wt % to about 15 wt %, based on the weight of the prepolymer, such as from about 2.5 wt % to about 10 wt %, or from about 10 wt % to about 15 wt %, or from 8 wt % to 12 wt %.

According to an optional embodiment, at least one catalyst can be optionally used in the reaction for preparing the above indicated prepolymer or the reaction between the prepolymer and the chain extender. Catalyst may include any substance that can promote the reaction between the isocyanate group and the isocyanate-reactive group, such as organic tin, organic bismuth, tertiary amine, morpholine derivative, piperazine derivative, and combination thereof.

The content of the catalyst used herein is larger than zero and is at most 1.0 wt %, or at most 0.5 wt %, or at most 0.1 wt %, or at most 0.05 wt %, based on the weight of the prepolymer.

According to another specific embodiment, when an acidic internal emulsifier, e.g. an internal emulsifier having one or more carboxylic group, is used during the preparation of the prepolymer, it may be necessary to neutralize the prepolymer before blending it with water and the chain extender. The neutralizer for the prepolymer may comprise at least one organic base, such as trimethylamine, triethylamine, tripropylamine, tributylamine, tripentylamine, trihexylamine, trimethanolamine, triethanolamine, and any combinations thereof. The content of the neutralizer used herein can be from 0.1 wt % to 8 wt %, based on the weight of the prepolymer, or from 1 to 5 wt %, or from 1.5 to 2 wt %.

According to various embodiments of the present embodiment, the prepolymer may be prepared optionally in the presence of one or more organic solvent which can properly adjust the viscosity, easy to clean capability, stability or other fluid properties of the prepolymer system. Without being limited to any specific theory, the PUD can be prepared in the presence of any suitable solvents. According to one embodiment, hazardous and/or flammable solvents like dimethylformamide (DMF), dimethylacetamide (DMAc), N-methyl pyrrolidone (NMP), acetone, etc. are not used during the preparation of the PUD. According to another embodiment, the PUD is free of any hazardous and/or flammable solvent. According to a specific embodiment, the organic solvent is environmentally friendly and may include dipropyleneglycol dimethyl ether. The content of the organic solvent can be from 0 wt % to 50 wt %, based on the weight of the prepolymer, or from 0.5 wt % to 35 wt %, or from 1 wt % to 20 wt %, or from 2 wt % to 10 wt %.

As stated above, the prepolymer thus prepared can be further mixed with chain extender and water, thus incurring the reaction between the prepolymer and the chain extender to extend the polyurethane chains and increase the molecular weight thereof, and the polyurethane particles thus obtained were dispersed within the water or aqueous solvent to form the PUD. According to an embodiment, the chain extender may include amine based chain extender, such as propylenediamine (PDA), aminoethyethanolamine (AEEA), hexanediamine (HDA), polyetheramine, amino siloxane and any combinations thereof.

According to an embodiment, the chain extender can be used in the form of an aqueous solution or aqueous dispersion having a solid content from about 20 wt % to 40 wt %.

According to a specific embodiment, the chain extender can be a polyetheramine having an amino functionality of about 2.0 to 3.0 and a weight average molecular weight of 150-600 g/mol, or from 200 to 300 g/mol, or from 230 to 300 g/mol. Particular examples of the polyetheramine may include Jeffamine D-230, Jeffamine D-400, Jeffamine ED-600, and any combinations thereof.

Alternatively or additionally, the chain extender may include amino siloxane, such as a hydrophilic amino siloxane compound comprising a silicon-oxygen backbone chain to which nitrogen-containing side chain and hydrophilic side chain are attached. For example, the hydrophilic amino siloxane compound may have a molecular structure represented by Formula I:

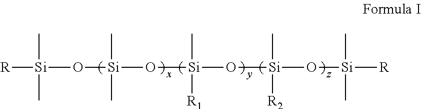

wherein each R independently represents methyl, ethyl, n-propyl, i-propyl, n-butyl, i-butyl, s-butyl, t-butyl, n-pentyl, i-pentyl, tert-pentyl, neo-pentyl, cyclohexyl, phenyl, tolyol, vinyl, allyl or —(OCH₂CH₂)₍₁₋₁₀₎—O—CH₂—CH═CH₂;
R₁ is —(CH₂)₍₁₋₁₀₎NH₂ or —(CH₂)₍₁₋₁₀₎—NH—(CH₂)₍₁₋₁₀₎NH₂;
R₂ is —CH₂CH₂CH₂O (CH₂CH₂O)ₐH; and
wherein x is an integer of 20-500, such as from 20 to 200, or from 50 to 150, or from 80 to 120, or from 90 to 100; y is an integer of 1-20, or from 1 to 10, such as an integer of 1, 2, 3, 4, 5, 6, 7, 8, 9, 10, 11, 12, 13, 14, 15, 16, 17, 18, 19 or 20; z is an integer of 1-20, or from 1 to 10, such as an integer of 1, 2, 3, 4, 5, 6, 7, 8, 9, 10, 11, 12, 13, 14, 15, 16, 17, 18, 19 or 20; t is an integer of 1-10, or from 1 to 5, such as an integer of 1, 2, 3, 4, 5, 6, 7, 8, 9 or 10; and a is an integer of 1-30, such as from 5 to 20, or from 10 to 15. A particular example of the hydrophilic amino siloxane chain extender may include XIAMETER OFX-7700.

According to another embodiment, the content of the chain extender is configured so that the molar ratio between the amine groups in the chain extenders and the free NCO groups remained in the prepolymer is within the range of 2:100 to 99:100, such as from 10:100 to 90:100, or from 20:100 to 80:100, or from 30:100 to 70:100, or from 40:100 to 60:100.

Water, such as deionized water, can be used for preparing the PUD. The content of water can be properly selected so that the PUD has a suitable solid loading of polyurethane particles, such as at from 20 wt % to 70 wt %, or from 30 wt % to 60 wt %, or from 40 wt % to 45 wt %. According to a particular embodiment, the polyurethane dispersion formulation comprises from 35 wt % to 60 wt % of water, from 1 wt % to 25 wt % of the chain extender and from 20% to 60 wt % of the prepolymer, based on the total weight of the polyurethane dispersion formulation; wherein the content of water can be from 40 to 50 wt %, or from 42 wt % to 48 wt %, the content of the chain extender can be from 5 wt % to 25 wt %, or from 10 wt % to 22 wt %, or from 15 to 20 wt %, and the content of the prepolymer can be from 25 wt % to 50 wt %, or from 30 wt % to 45 wt %, or from 32 wt % to 40 wt %.

The PUD may optionally contain a rheological modifier such as thickeners which can adjust the viscosity of the PUD to a range suitable for applying a skin layer onto a release paper. Examples of useful rheological modifiers include methyl cellulose ethers, alkali swellable thickeners (e.g., sodium or ammonium neutralized acrylic acid polymers), hydrophobically modified alkali swellable thickeners (e.g., hydrophobically modified acrylic acid copolymers), associative thickeners (e.g., hydrophobically modified ethylene-oxide-based urethane block copolymers), and methylcellulose ether. The amount of thickener can be from about 0.1 wt % to about 5 wt %, based on the total weight of the PUD, or from about 0.2 wt % to about 2 wt %, or from about 0.3 wt % to about 1 wt %. According to another embodiment, no thickener/rheological modifier is added into the PUD.

Generally, the waterborne PUD has a viscosity from at least about 10 cp to at most about 10,000 cp, or from about 30 cp to about 3000 cp.

In an embodiment, the dispersion of the polyurethane particles in the waterborne PUD can be promoted by high shear stirring action, wherein the shear force and stirring speed can be properly adjusted based on specific requirement.

According to one embodiment, the waterborne PUD may further comprise one or more pigment, dyes and/or colorant, all of which are generally termed as “color masterbatch” in the present disclosure. Examples of pigment dyes and/or colorants may include iron oxides, titanium oxide, carbon black and mixtures thereof. The amount of the pigment, dyes and/or colorant may be 0.1 wt % to 15 wt %, or from 0.5 wt % to 10 wt %, or from 1 wt % to 5 wt %, based on the total weight of the PUD. Additional additives like crosslinker (such as aziridine-type crosslinker), slipping agent, leveling agent, slow-drying agent (such as propylene glycol), wetting agent, hand feeling agent, co-solvent, foam stabilizer, anti-foaming agent, defoamer (such as organic silicone) may also be properly selected and incorporated in the PUD formulation based on the requirements on the synthetic leather application.

According to one embodiment, a release paper can be coated with a layer of the above indicated PUD until a wet film thickness of about 100 to 500 μm, such as from 150 to 400 μm, or from 250 to 300 μm; and then dried in an over at an elevated temperature from about 60 to 160° C., or from 80 to 130° C., or from 90 to 100° C., for a duration from 10 seconds to 30 minutes, such as from 30 seconds to 20 minutes, or from 1 minute to 15 minutes, or from 5 minute to 8 minutes; then the release paper and the dried PUD skin layer was taken out from the oven and cooled down. After the applying of the foam layer on the skin layer and the applying of the fabric layer onto the foam layer, a precursor leather without the silicone based top layer is obtained, and then a layer of the siloxane formulation can be coated onto the top surface of the skin layer and cured, thus forming the synthesis leather product.

According to one embodiment, the silicone formulation for preparing the top layer comprises a first polysiloxane functionalized with at least one Si—H group. According to an embodiment, the first polysiloxane is functionalized with one, two, three, four, five, six or more Si—H groups and have a polymerization degree in the range of about 5 to 1,000, such as from 50 to 700, or from 200 to 500. According to another embodiment, the silicone formulation for the top layer may further comprises a second polysiloxane functionalized with at least one vinyl group. According to an embodiment, the second polysiloxane is functionalized with one, two, three, four, five, six or more vinyl groups and have a polymerization degree in the range of about 2 to 2,000, such as from 100 to 1,200, or from 300 to 800, or from 400 to 700. According to an embodiment, the silicone formulation for the top layer may comprise from 10 to 70 wt % of the first polysiloxane, from 10 to 70 wt % of the second polysiloxane and from 10 to 50 wt % of at least one solvent, based on the total weight of the silicone formulation.

According to an embodiment, the content of the first polysiloxane can be from 10 to 70 wt %, based on the total weight of the silicone formulation, such as from 30 to 60 wt %, or from 40 to 50 wt %. According to another embodiment, the content of the second polysiloxane can be from 10 to 70 wt %, based on the total weight of the silicone formulation, such as from 20 to 65 wt %, or from 50 to 60 wt %. According to another embodiment, the solvent can be selected from the group consisting of water (e.g. deionized water, monol, diol, or combinations thereof), and can be present at a content of about 10 to 50 wt %, based on the total weight of the silicone formulation, such as from 20 to 40 wt %, or from 20 to 30 wt %.

According to an additional embodiment, the silicone formulation for the top layer may optionally comprise one or more additional additives or adjuvants, such as from 0 to 50 wt % of a third polysiloxane comprising one or more silanol groups, from 0 to 30 wt % of a fire retardant, from 0 to 35 wt % of fillers (such as hollow ceramic particles having a volume mean particle size in the range of from 25 μm to 300 μm), and catalytic amount of a hydrosilylation catalyst.

According to an exemplary embodiment, the hydrosilylation catalyst can be a platinum-based catalyst such as chloroplatinic acid and is used in a catalytic amount, typically in the range from 0.5 ppm to 200 ppm of Pt, based on the total weight of the silicone formulation.

According to another exemplary embodiment, the silicone formulation for the top layer can be a two-part formulation, wherein the first polysiloxane and the hydrosilylation catalyst can be included in part A while the second polysiloxane is included in part B. Examples of commercial liquid silicone suitable for the top layer include Dowsil LCF 8300 and Dowsil LCF 8500, both of which are available from Dow.

According to an embodiment, the top layer can be formed by coating an exposed surface of the polyurethane based skin layer with the above indicated silicone formulation to a wet film thickness of about 1 to 100 μm, such as from 5 to 50 μm, or from 8 to 20 μm; and then heating the coated laminate in an over at an elevated temperature from about 100 to 160° C., or from 120 to 160° C., or from 140 to 150° C., for a duration from 10 seconds to 30 minutes, such as from 30 seconds to 20 minutes, or from 1 minute to 10 minutes, or from 2 minute to 10 minutes; thus producing the multi-layer synthetic leather product.

Suitable release layers are typically known in the prior art as “release paper”. Examples of suitable release layers include foils of metal, plastic or paper. The release layer generally has a thickness of 0.001 mm to 10 mm, preferably from 0.01 mm to 5 mm, and more preferably from 0.1 mm to 2 mm. The material and the thickness of the release layer can be properly adjusted, as long as the release layer is able to endure the chemical reaction, mechanical processing and thermal treatments experienced during the manufacturing procedures and can be readily peeled from the resultant synthetic leather without bringing about the detachment between the skin layer and the foam layer.

According to an embodiment, the foam layer can be formed by a 1K PU foam, a 2K PU foam, a mechanically frothed PU foam, preferably a non-solvent PU foam and comprises a continuous PU matrix that defines a plurality of pores and/or cells therein. According to one embodiment, the foam layer may be formed by blending a mechanical frothing PU material (such as an aqueous dispersion of PU, and especially, SCISKY KT-650 available from Scisky) with one or more processing aiding agents selected from the group consisting of surfactant, emulsifier, thickening agent, foaming agent, catalyst, dispersing agent, dispersing aid, foam stabilizer and filler under mechanical stirring, applying the blend onto the skin layer. Then the fabric layer is applied to the foam layer with the assistance of a pressing roller. One or more curing steps may be conducted after the applying of any one of the skin layer, the foam layer and the fabric layer. According to an embodiment, the release layer is removed after the fabric layer, foam layer and the skin layer have been applied or before the applying of the top layer. The release layer can be peeled off via any ordinary technologies.

In an embodiment, the fabric layer may have a thickness of in the range from 0.01 mm to 50 mm, such as in the range from 0.05 mm to 10 mm or in the range from 0.1 mm to 5 mm. The fabric layer may comprise one or more materials selected from the group consisting of fabric, such as woven or nonwoven fabric, impregnated fabrics, knit fabric, braid fabric or microfiber; foil of metal or plastic, e.g. rubber, PVC or polyamides; and leather, such as split leather.

According to an embodiment, the fabric layer can be made of a woven or nonwoven textile. Suitable fibrous materials include, but are not limited to, synthetic fibrous materials and natural or semi synthetic fibrous materials and mixtures or blends thereof. Examples of synthetic fibrous materials include polyesters, polyamides, acrylics, polyolefins, polyvinyl chlorides, polyvinylidene chlorides, polyvinyl alcohols and blends or mixtures thereof. Examples of natural semi-synthetic fibrous materials include cotton, wool and hemp.

According to various embodiments, each layer of the synthetic leather product may be applied by conventional coating technologies such as spraying coating, blade coating, die coating, cast coating, dip coating, roll coating, etc.

The multilayer structure synthetic leather disclosed herein can be cut or otherwise shaped so as to have a shape suitable for any desired purpose, such as sofa manufacturing. Depending on the intended application, the synthetic leathers can be further treated or post-treated similarly to genuine leathers, for example by brushing, filling, milling or ironing. If desired, the synthetic leathers may (like genuine leather) be finished with the customary finishing compositions. This provides further possibilities for controlling their character. The multilayer structure disclosed herein may be used in various applications particularly suitable for use as synthetic leather, for example, garment, sofa, glove, handbag, luggage, purse, belt, furniture upholstery, inhouse or outhouse decoration, automotive parts, medical instrument and electronic device.

### EXAMPLES

Some embodiments will now be described in the following Examples, wherein all parts and percentages are by weight unless otherwise specified. However, the scope is not limited to the formulations set forth in these examples. Rather, the Examples are merely inventive of the disclosure.

The information of the raw materials used in the examples is listed in the following table 1:

TABLE 1
Raw materials used in the examples

| Raw Material | Description | Vendor |
|---|---|---|
| IPDI | Isophorone diisocyanate, an aliphatic isocyanate, | Covestro |
| | functionality = 2 | |
| PTMEG-2000 | Poly-tetrahydrofuran, Mw = 2000 g/mol, Functionality = 2 | BASF |
| VORANOL ™ 4000LM | Polyether polyol, Mw = 4000 g/mol, Functionality = 2 | Dow |
| DMBA | 2,2-Dimethylolbutanoic acid, Internal emulsifier | Sinopharm |
| KH-15A | Allyl polyether monoalcohol having allyl group(s) and | Jiangsu |
| | hydroxyl group(s), Mw = about 1,750 g/mol, OH number = | Zhongshan |
| | 32 ± 3 mg KOH/g | |
| HDPOL-1500M | (hexane diacid)—(maleic anhydride)—(glycol)—(diethylene glycol) | Huide |
| | based polyester polyol with one C═C double bond within the | Science & |
| | polymer chain | Technology |
| DABCO ® MB20 | Catalyst (organic bismuth) | Evonik |
| DMM | Dipropyleneglycol dimethyl ether, Green solvent | Dow |
| TEA | Triethylamine, neutralizer | Sinopharm |
| Jeffamine D-230 | Polyetheramine chain extender, Mw = 230 | Huntsman |
| XIAMETER ™ OFX-7700 | Hydrophilic amino silicone chain extender | Dow |
| ACRYSOL ™ RM-825 | Nonionic urethane rheology modifier | Dow |
| DOWSIL ™ 8590 | Silicone based defoamer | Dow |
| BYK 346 | Silicone based leveling agent | BYK |
| ROSILK ™ 2229 | Silicone based hand feeling modifier | Dow |
| Trimethylolpropane tris(2- | Aziridine crosslinker (CAS: 64265-57-2) | Jinju |
| methyl-1-aziridinepropionate) | | Leather |
| DOWSIL ™ 5211 Fluid | Silicone based wetting agent | Dow |
| Black 525 | Black color master batch | Jinju Leather |
| SCISKY KT-650 | PUD for foam layer | Scisky |
| ORTEGOL EP-P 112 | Surfactant for PUD foam layer frothing | Evonik |
| ACRYSOL ™ 830 | Acrylic based thickener for foam layer | Dow |
| SILASTIC ™ LCF 8700 | Si-H functionalized polysiloxane for the top layer | Dow |
| PART A | | |
| SILASTIC ™ LCF 8700 | Si-vinyl functionalized polysiloxane for the top layer | Dow |
| PART B | | |
| DI water | Deionized water, ice cold | — |

### Preparation Example A: The Preparation of Prepolymers

The prepolymers for the Inventive Examples (IE) 1-3 and Comparative Examples (CE) 1-4 were prepared by the following procedures: the polyols (including the PTMEG-2000 and the VORANOL™ 4000 LM), the internal emulsifier (DMBA), and the allyl polyether monoalcohol (KH-15A) or the comparative counterpart agent (HDPOL-1500M) were separately weighed according to the relative amounts listed in Table 2 and charged into a 500 mL three neck flask and dehydrated at 115° C. under 76 mmHg pressure for 0.5 h, then the dehydrated polyol mixture was naturally cooled down to a temperature of 60° C. Specific amount of IPDI was weighed according to Table 2 and poured into the dehydrated polyol mixture at the same temperature under the protection of nitrogen (N₂) flow and mechanical stirring, then 0.05 g catalyst Dabco® MB20 was added into the flask. The reaction lasted at 70° C. for around 30 minutes, and then was heated to 80° C. and continued to react at this temperature for 3 hours. The reaction system was cooled down to a temperature below 60° C., and then 2.9 g DMM was added therein. After being stirred for 20 minutes, 1.56 g TEA was added into the mixture for neutralization. The reaction system was stirred for another 10 minutes, thus producing the prepolymer which was transferred into a plastic cup (3 L) for the preparation of polyurethane dispersion.

TABLE 2
Formulation for the prepolymers of IE 1-3 and CE 1-4,
wherein all the contents are described in gram.

| Raw materials | CE 1 | CE 2 | CE 3 | CE 4 | IE 1 | IE 2 | IE 3 |
|---|---|---|---|---|---|---|---|
| DMBA | 2.86 | 2.86 | 2.86 | 2.86 | 2.86 | 2.86 | 2.86 |
| KH-15A | 17.5 | 0 | 1 | 0 | 15 | 10 | 2.5 |
| HDPOL-1500M | 0 | 10 | 0 | 0 | 0 | 0 | 0 |
| PTMEG 2000 | 46.09 | 51.69 | 60.28 | 61.05 | 48.24 | 52.55 | 58.99 |
| VORANOL ™ 4000LM | 9.53 | 9.53 | 9.53 | 9.53 | 9.53 | 9.53 | 9.53 |
| Total amount of | 75.98 | 74.08 | 73.67 | 73.44 | 75.63 | 74.94 | 73.88 |
| polyols | | | | | | | |
| IPDI | 19.5 | 21.40 | 21.81 | 22.04 | 19.85 | 20.54 | 21.6 |
| Dabco MB20 | 0.05 | 0.05 | 0.05 | 0.05 | 0.05 | 0.05 | 0.05 |
| DMM | 2.91 | 2.91 | 2.91 | 2.91 | 2.91 | 2.91 | 2.91 |
| TEA | 1.56 | 1.56 | 1.56 | 1.56 | 1.56 | 1.56 | 1.56 |
| Total amount of | 100.00 | 100.00 | 100.00 | 100.00 | 100.00 | 100.00 | 100.00 |
| PU prepolymer | | | | | | | |

### Preparation Example B: The Preparation of PUD

The internally emulsified polyurethane dispersions of the IE 1-3 and CE 1-4 were prepared according to the following procedures by using the prepolymers as prepared above: 100 g of the prepolymer was transferred into a 1 L plastic beaker and stirred with a gear-shaped dispersion plate under a rotation speed of 3000 rpm. Ice water was added into the plastic beaker, and then the stirring continued for another 5 minutes, after which an emulsion was formed and the stirring speed was decreased to 2000rpm. A mixture of 40% aqueous solution of JEFFAMINE® D-230 and 20% aqueous solution of XIAMETER™ OFX-7700 Fluid were gradually added into the emulsion. Then the emulsion was further stirred for another 15 minutes, thus producing the PUD, which was retained in this plastic beaker covered with a lid for degassing overnight. On the next day, the substance was filtrated through a #100 mesh, thus producing the final PUD products having a solid content of 40%. Relative contents of the ingredients for preparing the PUD were summarized in Table 3.

TABLE 3
Formulation for the polyurethane dispersion

| Raw materials | Wt % |
|---|---|
| Prepolymer | 35.55 |
| Ice cold di-ionized water | 45.69 |
| 40% aqueous solution of JEFFAMINE ® D-230 | 8.86 |
| 20% aqueous solution of XIAMETER ™ OFX-7700 | 9.90 |
| Solid content % | 40% |

### Preparation Example C: The Preparation of Stand-Alone PU film by Using the PUD

The internally emulsified polyurethane dispersions of the IE 1-3 and CE 1-4 as prepared above were used for preparing a stand-alone PU film for characterizing the mechanical properties such as tensile strength, elongation at break, and modulus at 100% elongation. In particular, 15 g of the PUD was transferred into a speed mixer and degassed by stirring at a rotation speed of 3000rpm for 3 min. Then 1 g of the degassed PUD was poured onto the surface of a plastic petri dish. After drying at room temperature overnight, the dish was transferred into an oven and further dried under 54° C. for 24 h. Then the film was peeled off, reversed and further dried under 54° C. for another 24 h, after which the film was cooled down to ambient temperature for further characterizing.

### Preparation Example D: The Preparation of Synthetic PU Leather Without the Silicone Based Top Layer

Each of the polyurethane dispersions of the IE 1-3 and CE 1-4 was blended with the color paste, crosslinker, thickener, leveling agent, wetting agent, hand feeling modifier and anti-foaming agent according to the formulation shown in Table 4 and the mixture was mixed at high speed (3000 rpm) for several minutes. The PUD based coating material thus formulated was coated on a release paper to a wet film thickness of 100 μm. The coated release paper was dried in an oven at 100° C. for 5 min. The release paper with dried PUD skin layer was taken out from the oven, and cooled down to ambient temperature. The PUD foam layer with 250% foaming ratio by mechanical frothing (see Table 5) was coated on the dried PU skin layer, to a wet film thickness of 400 μm. The release paper with the PU skin layer and the coated foam layer was transferred into a 130° C. oven and pre-cured for 10 min. The PU foam layer was then coated again on the coated release paper with the same thickness, carefully place the fabric cloth onto the wet foam layer and pressed with a 1 kg roller twice. Then the leather specimen was put into a 130°° C. oven and post-cured for 10 min and then taken out and cooled down. The release paper was peeled off to obtain a PU based synthetic leather sample without the silicone based top layer.

TABLE 4
Formulation for the PU based skin layer

| Function | Components | Dosage (g) |
|---|---|---|
| PU resin | PUD | 100 |
| Leveling agent | BYK 346 | 1 |
| Anti-foaming | DOWSIL ™ 8590 | 0.5 |
| agent | | |
| Hand feeling | ROSILK 2229 | 0.5 |
| modifier | | |
| Cross-linker | Trimethylolpropane tris(2- | 1 |
| | methyl-1-aziridinepropionate) | |
| Thickener | ACRYSOL RM-825 | 0.3-0.4 |
| | | (for adjusting |
| | | the viscosity |
| | | to 3000 cps) |
| Wetting agent | DOWSIL 5211 Fluid | 0.5 |
| Color paste | Black 525 | 5 |

TABLE 5
Formulation for the foam layer

| Function | Components | Dosage (g) |
|---|---|---|
| PU resin | SCISKY KT-650 | 100 |
| Foam stabilizer | ORTEGOL EP-P 112 | 4 |
| Thickener | ACUSOL 830 | 2 |

### Preparation Example E: The Preparation of Synthetic Leather With the silicone Based Top Layer

In this preparation example, a silicone based top layer was applied onto the exposed surface of the PU based skin layer of each synthetic leather of the IE 1-3 and CE 1-4 as prepared above. In particular, 10 g SILASTICLCFIM 8700 Part A (containing Pt catalyst) and 10 g SILASTICTM LCF 8700 Part B were blended together by using a speed mixer at 3000 rpm for 3 min. Then the mixture was coated onto the exposed surface of the PU based skin layer of each synthetic leather of the IE 1-3 and CE 1-4 as prepared above to a wet thickness of about 5 μm. The whole sample was transferred into an oven and cured at 140° C. for 5 min, after which the sample was taken out of the oven and cooled down to ambient temperature, thus obtaining the final semi-Si synthetic leather.

Two additional comparative examples, CE 5 and CE 6, were conducted, wherein a silicone based top layer was coated onto the exposed surface of the PU based skin layer of the synthetic leather of IE 1, except that the silicone based top layer of CE 5 solely comprises 20 g SILASTICLCF 8700 Part A and the silicone based top layer of CE 6 solely comprises 20 g SILASTICLCF 8700 Part B.

The synthetic leather prepared in CE 5 exhibits poor adhesion strength between the skin layer and the top layer, and the top layer readily delaminated from the skin layer after several times of winding and bending.

With regard to the synthetic leather prepared in CE 5, in spite of heating and curing treatment under elevated temperature, the top layer kept uncured for even several days, and the outer surface of the top layer is sticky and wet.

### Technologies for Characterizing the Products The PUD, PU film and synthetic leather samples of the inventive examples and comparative examples were characterized by the following technologies.

### (a) Particle Size in the Polyurethane Dispersion

The particle size of the PU particles in the polyurethane dispersion was evaluated by using a Zetasizer-Beckman LS230 particle size analyzer.

### (b) Viscosity of the Polyurethane Dispersion

The viscosity of the polyurethane dispersion was evaluated by using a Brookfield viscometer with the temperature set to be 25° C. A S64 rotor was selected and the rotation speed was set to be 100 rpm. During the test, the calibration line on the rotor should be placed below the liquid level.

### (c) Appearance of the Polyurethane Dispersion

The polyurethane dispersion was transferred into a transparent plastic bottle and viewed with naked eyes through the transparent bottle wall.

### (d) Mechanical Properties of the Stand-Alone PU Film

The mechanical properties, including tensile strength, elongation at break, and modulus at 100% elongation, of the stand-alone PU film were evaluated according to the ASTM D412-15a.

### (e) Hand Feeling Performance of the Synthetic Leather Without the Top Layer

The hand feeling performance of the synthetic leather without the top layer was evaluated by a group of ten professional staffs who grade the leather samples, ranging from 1 to 5, according to visual check and hand touching, and average score was calculated and reported for each sample, wherein 5 represents a dry and clean surface with good hand feeling, and 1 represents a sticky and wet surface with poor strength.

### (f) Easy to Clean Capability of the Synthetic Leather With the Top Layer

The easy to clean capability of the synthetic leather having the top layer was characterized by drawing a pattern with an oily pen on the surface of the top layer, and then wiping the pattern with a cloth tissue. Repeating the above indicated drawing-wiping recycle until the pattern is no longer cleanable. Recording the number of the recycle and reporting it as a means for evaluating the easy to clean capability. A larger number represents a better easy to clean capability, and a recycle number of at least 10 is required for a qualified synthetic leather.

The characterization results of all the inventive examples and comparative examples are summarized in the following Table 6.

TABLE 6
The characterization results of IE 1-3 and CE1-5

| | | | | | | | | | | | Leather | Leather |
|---|---|---|---|---|---|---|---|---|---|---|---|---|
| | | | | | | | | Stand-alone PUD film | | | without | with top |
| | | | | | | | | Elongation | Tensile | | top coat | coat |
| | Allyl | Liquid PUD emulsion | | | | | | (%, | (MPa, | | Skin Layer | Easy to |
| | content in | Particle size (nm) | | | | PUD | Viscosity | CTQ ≥ | CTQ ≥ | Modulus | Status | Clean |
| | prepolymer(wt %) | D50 | D90 | D10 | S.D. | Appearance | (mPa · s) | 700%) | 5 MPa) | (MPa) | (CTQ ≥ 4) | (CTQ > 10) |
| CE 1 | 0.278 | 87 | 125 | 60 | 25 | Semilucent | 150 | 1897.74 | 4.44 | 0.51 | 3 (Some | 15 |
| | | | | | | | | | | | holes) | |
| CE 2 | 0.173 | 229 | 1333 | 89 | 553 | Milky | 350 | 903.15 | 20.22 | 2.23 | 5 | 5-10 |
| | | | | | | | | | | | (Good) | |
| CE 3 | 0.016 | 161 | 207 | 125 | 31 | Milky | 25 | 993.4 | 32.55 | 2.34 | 4 (Tiny | 10 |
| | | | | | | | | | | | holes) | |
| CE 4 | 0.000 | 125 | 229 | 71 | 62 | Milky | 220 | 795.04 | 25.73 | 2.39 | 5 | 5-10 |
| | | | | | | | | | | | (Good) | |
| IE 1 | 0.239 | 87 | 124 | 60 | 25 | Semilucent | 103 | 1683.93 | 5.90 | 0.64 | 5 | 20 |
| | | | | | | | | | | | (Good) | |
| IE 2 | 0.159 | 94 | 143 | 62 | 32 | Semilucent | 98 | 1566.47 | 12.93 | 1.02 | 5 | >50 |
| | | | | | | | | | | | (Good) | |
| IE 3 | 0.040 | 112 | 203 | 67 | 54 | Milky | 61 | 1092.65 | 25.68 | 1.63 | 5 | 15 |
| | | | | | | | | | | | (Good) | |

As can be seen from the characterization results summarized in Table 6, all the inventive examples exhibit much better performance properties, including better mechanical strength, superior hand feeling and enhanced easy to clean capability. On the contrary, none of the comparative examples can achieve the superior results in all the performances, each of comparative examples exhibits at least one unacceptable and inferior result in the above indicated properties.

Besides, the comparison of IE 2 with IE 1 and IE 3 illustrates that the relative amount of the allyl polyether monoalcohol ingredient can be adjusted to an optimized level (of IE 2) so as to achieve a significant improvement in the easy to clean capability over the other two inventive examples IE 1 and IE 3.

What is claimed is:

1. A multi-layer synthetic leather product, comprising
(A) a silicone based top layer which is the reaction product of a polysiloxane formulation comprising a first polysiloxane functionalized with at least one Si—H group and a second polysiloxane functionalized with at least one vinyl group; and
(B) a polyurethane based skin layer which is formed with a polyurethane dispersion formulation, wherein the polyurethane dispersion formulation is formed by blending water, at least one chain extender and an isocyanate-terminated prepolymer which is the reaction product of a mixture comprising:
(a) at least one isocyanate compound comprising at least two isocyanate groups;
(b) at least one polyol compound having a weight average molecular weight from 500 g/mol to 8000 g/mol; and
(c) from 2.5 wt % to 15 wt %, based on the weight of the prepolymer, of at least one allyl polyether monoalcohol having an allyl group and an hydroxyl group, and having a weight average molecular weight from 500 g/mol to 8,000 g/mol.

2. The multi-layer synthetic leather product of claim 1, wherein the top layer is chemically bonded with the skin layer via at least one bond selected from the group consisting of Si—C covalent bond, Si—O—C covalent bond, C—C covalent bond, and any combinations thereof.

3. The multi-layer synthetic leather product of claim 1, wherein the multi-layer synthetic leather product further comprises (C) a foam layer; and (D) a fabric layer.

4. The multi-layer synthetic leather product of claim 1, wherein the polyurethane dispersion formulation is internally emulsified and comprises from 35 wt % to 60 wt % of water, from 1 wt % to 25 wt % of the chain extender and from 20% to 60 wt % of the prepolymer, based on the total weight of the polyurethane dispersion formulation.

5. The multi-layer synthetic leather product of claim 1, wherein the prepolymer is the reaction product of,
(a) from 14 wt % to 38 wt %, based on the weight of the prepolymer, of an aliphatic isocyanate comprising at least two isocyanate groups;
(b) from 40 wt % to 70 wt %, based on the weight of the prepolymer, of a polytetramethylene ether glycol having a weight average molecular weight from 1,500 to 3,000 g/mol, and from 1 wt % to 15 wt %, based on the weight of the prepolymer, of at least one polyether polyol compound which is different from the polytetramethylene ether glycol and has a weight average molecular weight from 3,000 g/mol to 5,000 g/mol; and
(c) from 8 wt % to 12 wt %, based on the weight of the prepolymer, of the at least one allyl polyether monoalcohol having an allyl group and an hydroxyl group having a weight average molecular weight from 1,000 to 3,000 g/mol.

6. The multi-layer synthetic leather product of claim 4, wherein the isocyanate compound includes from 50 wt % to 100 wt % of isophorone diisocyanate, based on the weight of the component (a).

7. The multi-layer synthetic leather product of claim 1, wherein the chain extender comprises a polyetheramine having an amino functionality of 2 and a weight average molecular weight of 150-600 g/mol and an amino siloxane; and
the molar ratio between the amine groups in the chain extenders and the NCO groups in the prepolymer is within the range of 2:100 to 99:100.

8. The multi-layer synthetic leather product of claim 1, wherein the reaction for preparing the prepolymer further comprises from 1 wt % to 10 wt %, based on the weight of the prepolymer, of 2,2-dimethylolbutanoic acid as an internal emulsifier.

9. The multi-layer synthetic leather product of claim 1, wherein the silicone formulation comprises, based on the total solid weight of the silicone formulation,
(i) from 10 wt % to 70 wt % of the first polysiloxane which is functionalized with at least one Si—H groups and has a polymerization degree in the range from 5 to 1,000; and
(ii) from 10 wt % to 70 wt % of the second polysiloxane which is functionalized with at least one Si-vinyl groups and has a polymerization degree in the range from 2 to 2,000.

10. The multi-layer synthetic leather product of claim 1, wherein the multi-layer synthetic leather product is selected from the group consisting of garment, sofa, glove, handbag, luggage, purse, belt, furniture upholstery, inhouse or outhouse decoration, automotive parts, medical instrument and electronic device.
